(19) United States
(12) Patent Application Publication
(10) Pub. No.: US 2018/0242042 A1
(43) Pub. Date: Aug. 23, 2018

(54) METHOD AND APPARATUS FOR VOLUME CONTROL OF CONTENT

(71) Applicant: THOMSON Licensing, Issy-les-Moulineaux (FR)

(72) Inventors: Nan WANG, BEIJING (CN); Yongping GAI, BEIJING (CN)

(21) Appl. No.: 15/752,568

(22) PCT Filed: Aug. 14, 2015
(86) PCT No.: PCT/CN2015/086974

§ 371 Date: Feb. 13, 2018

(51) Int. Cl. H04N 21/454; H04N 21/439; H04N 21/475

(52) U.S. Cl. CPC H04N 21/454; H04N 21/4756; H04N 21/4396; H04N 21/4394

(57) ABSTRACT

A method and an apparatus for volume control of a digital television program are disclosed. The method comprises determining whether the content comprises both video data and audio data. If this determination is positive, it determines whether a language defined in the parental rating information of the content is consistent with a language of the audio data of the content. When a consistency is determined, it adapts the volume of the content as a function of the information on the rating of the content. And when an inconsistency is determined, it adapts the volume of the content as a function of the information on the type of the content.

### TECHNICAL FIELD

The present disclosure generally relates to content broadcasting. In particular, the present disclosure relates to a method and an apparatus for a volume control of content.

### BACKGROUND

An automatic volume control is needed in some cases for a digital broadcasting receiver, such as a digital TV set or a digital Set-Top-Box (STB). The digital TV set or Set-Top-Box can be compliant with the Digital Video Broadcasting (DVB) standards. The DVB standards are international standards for digital television, which are published by a Joint Technical Committee (JTC) of the European Telecommunications Standards Institute (ETSI), European Committee for Electrotechnical Standardization (CENELEC) and European Broadcasting Union (EBU). Other standards such as Advanced Television System Committee (ATSC) can have similar requirements as required for DVB.

It can be appreciated that, for example, there is a need in a limited space of a family residence to prevent the audio output of the digital TV set/STB from affecting some family members. An exemplary scenario is that the audio output of a TV program should not disturb family members who are sleeping in the night. Another scenario is that when adults watch a TV program with parental control, the sound of the program should not be heard by the children especially when the audio may have inappropriate words or sounds such as gunfire.

### SUMMARY

According to an exemplary aspect of the disclosure, a method for volume control of content is provided. The method comprises: determining whether the content comprises both video data and audio data, and if the determination is positive, determining whether a language defined in the parental rating information of the content is consistent with a language of the audio data of the content, when a consistency is determined, adapting the volume of the content as a function of the information on the rating of the content, and when an inconsistency is determined, adapting the volume of the content as a function of the information on the type of the content.

In an exemplary embodiment, the content represents a digital television program.

In an exemplary embodiment, the parental rating information is obtained from the Parental Rating Descriptor from a DVB Event Information Table (EIT) table delivered for the digital television program.

In another exemplary embodiment, the parental rating information is obtained from the Parental Rating Descriptor from an ATSC based Event Information Table (EIT) table delivered for the digital television program.

In an exemplary embodiment, the information on the rating is obtained from the Parental Rating Descriptor from a DVB Event Information Table (EIT) table delivered for the digital television program.

In an exemplary embodiment, the information on the type of the content is obtained from the Content Descriptor from a DVB Event Information Table (EIT) table delivered for the digital television program.

In an exemplary embodiment, the method further comprises implementing the method upon determination of the system time of the content being not in a set time period.

In an exemplary embodiment, the method further comprises presenting a user interface where in response to user input sets the time period.

According to another exemplary aspect of the disclosure, a receiver for receiving data of content is provided. The receiver comprises: a memory; a processor configured to: determine whether the content comprises both video data and audio data, and if the determination is positive, determine whether a language defined in the parental rating information of the content is consistent with a language of the audio data of the content, when a consistency is determined, adapt the volume of the content as a function of the information on the rating of the content, and when an inconsistency is determined, adapt the volume of the content as a function of the information on the content type of the content.

In an exemplary embodiment, the receiver receives content representing a digital television program.

In an exemplary embodiment, the parental rating information is obtained from the Parental Rating Descriptor from a DVB Event Information Table (EIT) table delivered for the digital television program.

In another exemplary embodiment, the parental rating information is obtained from the Parental Rating Descriptor from an ATSC based Event Information Table (EIT) table delivered for the digital television program.

In an exemplary embodiment, the information on the rating is obtained from the Parental Rating Descriptor from a DVB Event Information Table (EIT) table delivered for the digital television program.

In an exemplary embodiment, the information on the type of the content is obtained from the Content Descriptor from a DVB Event Information Table (EIT) table delivered for the digital television program.

In an exemplary embodiment, the processor is further configured to implement the steps when the system time of the content is not in a set time period.

In an exemplary embodiment, the receiver further comprises a user interface unit to present a user interface where in response to user input sets the time period.

According to another exemplary aspect of the disclosure, there is provided computer program comprising program code instructions executable by a processor for implementing the steps of the method according to the above described exemplary aspect of the disclosure.

According to another exemplary aspect of the disclosure, there is provided computer program product which is stored on a non-transitory computer readable medium and comprises program code instructions executable by a processor for implementing the steps of the method according to the above described exemplary aspect of the disclosure.

It is to be understood that more aspects and advantages of the disclosure will be found in the following detailed description of the present disclosure.

### BRIEF DESCRIPTION OF THE DRAWINGS

The accompanying drawings are included to provide further understanding of the embodiments of the disclosure together with the description which serves to explain the principle of the embodiments. The disclosure is not limited to the embodiments.

In the drawings:

FIG. 1 is an exemplary block diagram of a digital STB which is compliant with the DVB standards according to an embodiment of the disclosure;

FIG. 2 is an exemplary diagram showing a User Interface (UI) for a digital STB to configure a volume control function according to an embodiment of the disclosure; and

FIG. 3 is an exemplary flow chart showing the process for volume control of a digital broadcasting receiver according to an embodiment of the disclosure.

### DETAILED DESCRIPTION

An exemplary embodiment of the present disclosure will now be described in detail in conjunction with the drawings. In the following description, some detailed descriptions of known functions and configurations may be omitted for conciseness.

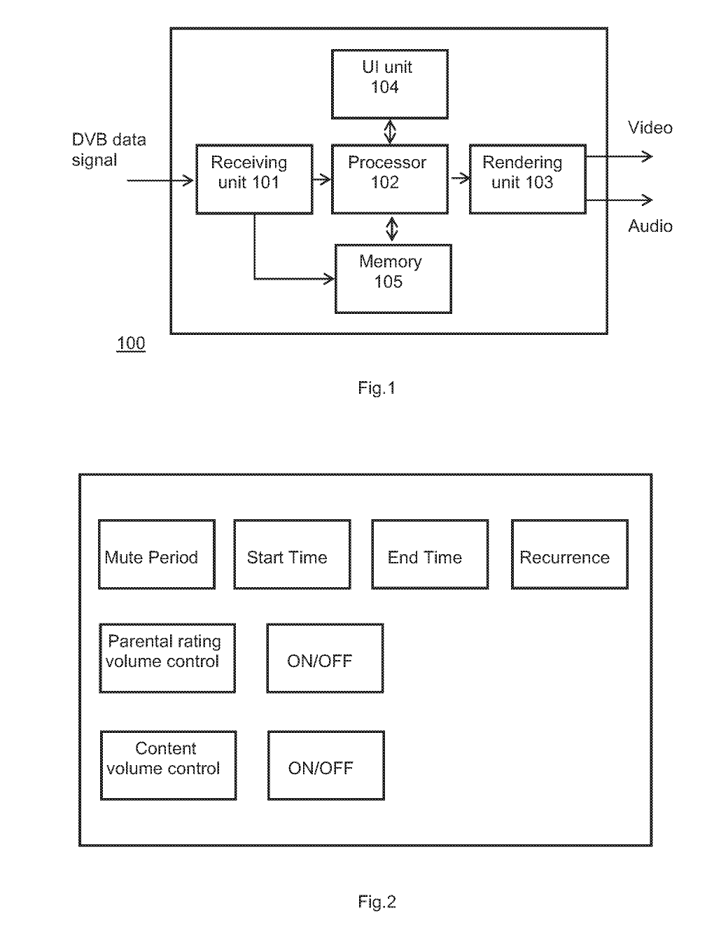

FIG. 1 is an exemplary block diagram of a digital STB which is compliant with the DVB standards according to an embodiment of the disclosure.

As shown in FIG. 1, the digital STB 100 comprises a receiving unit 101 to receive a DVB data signal which can be a DVB cable/satellite/terrestrial bitstream according to the DVB-C/DVB-S/DVB-T standards respectively. The receiving unit 101 can have a number of tuners and demodulators in order to perform the reception function on the incoming DVB-T, DVB-C and/or DVB-S data signals. In some embodiments, the receiving unit 101 can receive ATSC based data signals, satellite, IP streaming, cable, DSL, fiber, and the like based content signals. The receiving unit 101 can be configured to parse out the relevant program content data and information in the DVB data signals and forwards that information to a memory 105 prior to processing by a processor 102. Such information may comprise information for identifying and processing the program content data by the processor 102. No further details will be given in this respect.

The processor 102 in FIG. 1 receives the content data from the receiving unit 101 and processes the program content data according to the information stored in the memory 105 and user instructions obtained from a UI unit 104. The processor 102 can have a number of demultiplexers and decoders in order to perform the signal processing according to the DVB-T, DVB-C or DVB-S standards.

Once the processor 102 has processed the program content data, it will forward the processed data to a rendering unit 103. The program content data processed by the processor 102 can be rendered as audio and video signals. The rendering unit 103 can also process the audio and video signals received from the processor 102 in order to display the video signals on a display device (not shown) and output the corresponding audio signals to an audio device (not shown).

FIG. 2 is an exemplary diagram showing a User Interface (UI) for a digital STB to configure a volume control function according to an embodiment of the disclosure.

The UIs discussed below can be implemented by the UI unit 104 under the control of the processor 102 of the digital STB shown in FIG. 1. As shown in FIG. 2, the UI unit 104 can present a UI including option buttons for a user to configure a “Mute Period”, during which time the STB is set in a mute state. The user can configure the “Mute Period” in FIG. 1 by setting the “Start Time” and the “End time” option buttons. In an illustrative example, the default setting can be set as 11:00 p.m. to 6:00 a.m. of the local time, although other time durations can be used as well.

For a digital STB which is compliant with the DVB standards, the real time information can be retrieved from Time and Date Table (TDT) or Time Offset Table (TOT) which are delivered in Service Information (SI) tables. Service Information (SI) data forms a part of a DVB bitstream, in order that the user can be provided with information to assist in selection of services and/or events within the bitstream. Thus, an Integrated Receiver Decoder (IRD) of the digital STB can automatically configure itself for the selected service. The SI data is structured as various types of table, such as the above-mentioned TDT and TOT. In DVD standard documents, ETSI 300 468 (Digital Video Broadcasting (DVB); Specification for Service Information (SI) in DVB systems) defines the program service information.

As shown in FIG. 2, a “Recurrence” option button is presented, which can be used to set the applicability of the configured “Mute Period”. By default, the “Recurrence” can be set as “apply on a specific day”, in which case the configured “Mute Period” only applies on a specific day. For example, if the “Recurrence” is set to Sunday and the “Mute Period” is set to 10:00 p.m. to 5:00 p.m., the mute function of the STB only applies every Sunday from 10:00 p.m. to Monday 5:00 p.m. The “Recurrence” can also be set as “apply on every day”, in which case the mute function will apply on every day during the configured time period.

The UI of FIG. 2 can contain option buttons for the user to enable/disable a “Parental Rating Volume Control” function and/or a “Content Volume Control” function by using the “ON/OFF” buttons shown in FIG. 1. These control functions will be described in more details later. If the user does not enable this function, the STB will not check the program information and will not perform the automatic volume control discussed below.

The TV program information which can be used for the volume control functions described above can be obtained from the Event Information Table (EIT) or Service Description Table (SDT) delivered in SI tables, or from other sources in accordance with the disclosed principles.

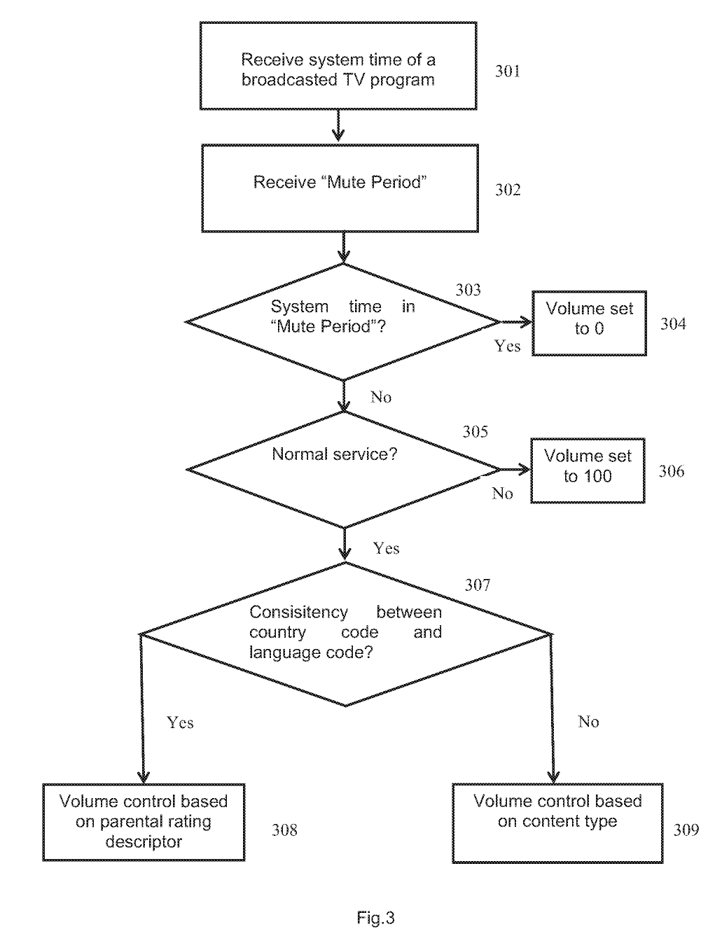

FIG. 3 is an exemplary flow chart showing the process for volume control of a digital broadcasting receiver according to an embodiment of the disclosure.

Please note that the process below will be implemented when the above-described “Content Volume Control” and “Content Volume Control” functions are enabled.

In the process of FIG. 3, the digital broadcaster receiver can be a digital STB which is compliant with the DVB standards shown in FIG. 1.

At step 301, after a STB boots after being turned on or goes out of a standby mode, the processor 102 gets the system time of a broadcasted TV program. For a DVB-based STB, the system time of the broadcasted TV program can be acquired from the TDT table which is delivered in the DVB SI tables. In other systems, the system time can be obtained from timing information that is part of the TV program.

At step 302, the STB receives the “Mute Period” time, for example, from above-described UI or retrieved from memory 105, and compares the current time with the “Mute Period” time.

At step 303, the STB determines whether the system time is in the window of the “Mute Period”.

If the system time is in the window of the “Mute Period”, at the step 304, the STB will set the volume to 0. This can be implemented by the rendering unit 103, under the control of the processor 102, to set the volume value of the audio output to 0. During this “Mute Period”, the volume control function is disabled. That is, it is forbidden to use the volume control function to increase/decrease volume or use the mute button to unmute the STB output.

If the system time is not in the window of the “Mute Period”, at the step 305, the STB will determine whether the broadcasted TV program is a service including both video data and audio data. Hereinafter, the service which includes both video data and audio data will be called a normal service. A service which only includes video data or audio data is not a normal service defined here.

The determination of whether the broadcasted TV program is a normal service in the step 305 can be made based on a service_descriptor defined in ETSI 300 468. Table 1 below shows an example of a service_descriptor defined in ETSI 300 468.

TABLE 1
Service_descriptor defined in ETSI 300 468

| Syntax | Number of bits | Identifier |
|---|---|---|
| service_descriptor ( ){ | | |
| descriptor_tag | 8 | Uimbsf |
| descriptor_length | 8 | Uimbsf |
| service_type | 8 | Uimbsf |
| ..... | | |
| } | | |

The volume control function only applies to a normal service defined here which includes both video data and audio data. It will not apply to a broadcasted TV program which is not defined as a normal service.

Table 2 below shows an example of the applicability of the volume control function based on the service_descriptor defined in SDT.

TABLE 2
Volume Control Applicable for different services

| service_type Description | Volume Control |
|---|---|
| 0x00 reserved for future use | Applicable |
| 0x01 digital television service (see note 1) | Applicable |
| 0x02 digital radio sound service (see note 2) | Not Applicable |
| 0x03 Teletext service | Not Applicable |
| 0x04 NVOD reference service (see note 1) | Applicable |
| 0x05 NVOD time-shifted service (see note 1) | Applicable |
| 0x06 mosaic service | Not Applicable |
| 0x07 FM radio service | Not Applicable |
| 0x08 DVB SRM service [48] | Not Applicable |
| 0x09 reserved for future use | Applicable |
| 0x0A advanced codec digital radio sound service | Not Applicable |
| 0x0B advanced codec mosaic service | Not Applicable |
| 0x0C data broadcast service | Not Applicable |
| 0x0D reserved for Common Interface Usage | Not Applicable |
| (EN 50221 [37]) | |
| 0x0E RCS Map (see EN 301 790 [7]) | Not Applicable |
| 0x0F RCS FLS (see EN 301 790 [7]) | Not Applicable |
| 0x10 DVB MHP service | Applicable |
| 0x11 MPEG-2 HD digital television service | Applicable |
| 0x12 to 0x15 reserved for future use | Applicable |
| 0x16 advanced codec SD digital television service | Applicable |
| 0x17 advanced codec SD NVOD time-shifted service | Applicable |
| 0x18 advanced codec SD NVOD reference service | Applicable |
| 0x19 advanced codec HD digital television service | Applicable |
| 0x1A advanced codec HD NVOD time-shifted service | Applicable |
| 0x1B advanced codec HD NVOD reference service | Applicable |
| 0x1C to 0x7F reserved for future use | Applicable |
| 0x80 to 0xFE user defined | Applicable |
| 0xFF reserved for future use | Applicable |

As shown in the Table 2, the volume control function applies to the normal service including both video data and audio data, such as a digital television service indicating by 0x01 and an MPEG-2 HD digital television service indicating by 0x11. It will not apply to those services such as a digital radio sound service indicating by 0x02, a teletext service indicating by 0x03 and a data broadcast service indicating by 0x0C.

For example, the volume output of a radio service can be set to be the maximal volume value (100 in this case) at the step 306.

If the result of the determination in the step 305 is “Yes”, at the step 307, it will determine the consistency between the syntax of “country_code” defined in the Parental Rating Descriptor of the broadcasted TV program and a language code of the audio data of the broadcasted TV program. In a DVB-based STB, the descriptor is defined in ETSI 300 468 and delivered in the DVB EIT tables. It can be appreciated that, for an ATSC-based STB, the parental rating information can be obtained from the Parental Rating Descriptor from an ATSC based Event Information Table (EIT) table delivered for the digital television program.

An example of the definition of a Parental Rating Descriptor is shown in Table 3 below.

TABLE 3
Parental Rating Descriptor definition

| Syntax | Number of bits | Identifier |
|---|---|---|
| parental_rating_descriptor( ){ | | |
| descriptor _tag | 8 | Uimbsf |
| descriptor_length | 8 | Uimbsf |
| for (i=0;i<N;i++){ | | |
| country_code | 24 | Bslbf |
| Rating | 8 | Uimsbf |
| } | | |

In the above Table 3, the “country_code” is a 24-bit field which identifies a country using the 3-character code as specified in ISO 3166. Each character is coded into 8-bits according to ISO/IEC 8859-1 and inserted in order into the 24-bit field. In the case that the 3 characters represent a number in the range 900 to 999, then country_code specifies an ETSI defined group of countries. These allocations are found in TR 101 162.

### EXAMPLE 1

### United Kingdom has 3-character code “GBR”, which is coded as: “0100 0111 0100 0010 0101 0010”

In the Parental Rating Descriptor, the syntax of “rating” is an 8-bit field which is coded according to a table 73 in DVB ETSI 300 468, giving the recommended minimum age in years of the end user.

An example of the definition of the “country_code” is shown in Table 4 below.

TABLE 4
Country Code ISO definition for local and international Languages

| 639-2/B | 639-2/T | Language |
|---|---|---|
| ger | Deu | German |
| Eng | Eng | English |
| Fre | Fra | French |
| Spa | Esp | Spanish |
| Ita | Ita | Italian |
| Por | por | Portuguese |

The STB will obtain the language code of audio track of the broadcasted TV program. It is possible that there are multiple audio tracks in the broadcasted TV program. In this case, the STB will get the language code of the currently playing audio track. The language code can be obtained from the Program Map Table (PMT) which is defined in ISO/IEC 13818-1. In this table, if the stream_type field value is audio, then the language code of the audio is defined in the following descriptor.

The STB will determine whether the language code is consistent with the country code as defined in the Parental Rating Descriptor. For example, English would be a language that is consistent with the country England, while German would be consistent for the country Germany. Other examples are possible in accordance with the disclosed principles.

If the language code and country code are consistent, at step 308, the volume output value will be set according to the syntax of rating in the Parental Rating Descriptor of the broadcasted TV program.

For example, if the user is watching a TV program with both French and German Track. If it is playing with the French audio track and the country_code in the parental_rating_descriptor is “fra”, then the STB will launch the volume control function. The STB volume will be set to the specified volume in the below list. If for example the parental rating limit of this playing content is less than 7 years, then the volume output will be automatically decreased or mute directly. The purpose is that the playing program is only for adult audience and not applicable for the children who may not be able to see the TV but can hear the sound from one space in the house.

Table 5 below shows an example of parental rating and default volume value output. In Table 5, the volume 100 is the maximal value and 0 is the minimal value.

TABLE 5
Parental rating and default volume output

| Limiting value | No limit | Volume Value |
|---|---|---|
| No limiting | See everything (no content is blocked) | 100 |
| 7 | The content may be harmful to children | 0 |
| | younger than 7 years. | |
| 11 | The content may be harmful to children | 0 |
| | younger than 11 years. | |
| 15 | The content may be harmful to children | 50 |
| | younger than 15 years, | |
| 18 | The content may be harmful to children | 75 |
| | younger than 18 years. | |

One context to set different volumes according to the syntax of parental rating of the broadcasted TV program is as below: if the adults are seeing the TV programs in one room and children are in another room, then children may hear the audio content of the broadcasted TV programs though they can see nothing. It should have the minor impact to the children according to their age while adults can also enjoy the programs at same time.

The volume values throughout the specification are described to explain the adaption of the content volume according to the embodiments of the disclosure. A volume value does not necessarily refer to the actual volume output of a speaker of the digital TV system. For example, the volume value of 100 does not mean that the speaker operates in the maximum power output. In an embodiment, a volume value can be set as a certain percentage/ratio of the actual volume output. The specific volume values in the tables are only examples for illustrative purpose, which can be changed according to the context of applications.

There may be one exception for the above volume control based on parental rating. If there is a DVB subtitle track available with the same country code in the parental_rating_descriptor, then the volume is automatically set to mute if there is limited value. This means that when there is DVB subtitle available in the parental rating controlled TV program, the playing of the TV program with sound is not mandatory for audience.

As shown in FIG. 3, if the language code is not consistent with the country code defined in the Parental Rating Descriptor, at step 309, the volume output value will be set based on the type of content of the broadcasted TV program. In an example, the type of content of the broadcasted TV program can be determined based on the Content_nibbel_level_1 information in the EIT content descriptor of the broadcasted TV program. In a DVB-based STB, the Content Descriptor is defined in ETSI 300 468 and delivered in the DVB EIT tables.

Table 6 below shows an example of Content Descriptor definition defined in ETSI 300 468.

TABLE 6
Content Descriptor definition defined in ETSI 300 468

| Syntax | Number of bits | Identifier |
|---|---|---|
| Content_descriptor ( ){ | | |
| descriptor_tag | 8 | Uimbsf |
| descriptor_length | 8 | Uimbsf |
| For (I=0; i<N;I++){ | | |
| content_nibble_level_1 | 4 | Uimbsf |
| content_nibble_level_2 | 4 | Uimbsf |
| User_byte | 8 | Uimbsf |
| } | | |
| } | | |

The referred EIT p/f information is for the content descriptor used in the EIT present/following information. If there is no content descriptor, the STB will not control the volume output.

The content_nibbel_level_1 is also defined in ETSI 300468. The function of the content descriptor is to provide classification information for an event. Different types of event are defined. Different types of events can be mapped to different volume values. For example, some events like Sports or Arts/Culture (without music) can be set with low volume values.

Table 7 below shows the Content_nibbel_level_1 is classified with different codes which represents different types of the content in the TV program.

TABLE 7
Content_nibbel_level_1 representing different program types

| Content_nibble_level_1 | Description |
|---|---|
| 0x1 | Movie/Drama |
| 0x2 | News/Current affairs |
| 0x3 | Show/Game show |
| 0x4 | Sports |
| 0x5 | Children's/Youth programmes |
| 0x6 | Music/Ballet/Dance |
| 0x7 | Arts/Culture (without music) |
| 0x8 | Social/Political issues/Economics |
| 0x9 | Education/Science/Factual topics |

Table 8 below shows an example of Content Nibbel_level_1 definition and its mapping to the different expect volume.

TABLE 8
Content Nibbel_level_1 definition and mapping to the
different volume values

| | | Default Volume |
|---|---|---|
| Content_nibbel_level_1 | | output values |
| code | Description | (0-100) |
| 0x1 | Movie/Drama: | 100 |
| 0x2 | News/Current affairs: | 100 |
| 0x3 | Show/Game show: | 100 |
| 0x4 | Sports: | 50 |
| 0x5 | Children's/Youth | 100 |
| | programs: | |
| 0x6 | Music/Ballet/Dance: | 50 |
| 0x7 | Arts/Culture | 0 |
| | (without music): | |
| 0x8 | Social/Political | 50 |
| | issues/Economics: | |
| 0x9 | Education/Science/ | 100 |
| | Factual topics: | |
| 0x0A | Leisure hobbies: | 50 |
| 0x0B | Special characteristics: | 50 |
| Others | Others | 50 |

One context to set different volumes according to the content descriptor is for the purpose of setting different volume outputs according to different types of the content. If the type of the content of the TV program is Sports (0x4 in the table 8) or pure Arts/Culture (0x7 in the table 8), the volume can be decreased. This is because the point of the audience does not focus on the audio of the TV program in this case. This means that if the audio information is not important for the audience, it can be decreased or mute automatically. Note, the volume levels can vary in other exemplary embodiments.

It is to be understood that the present invention may be implemented in various forms of hardware, software, firmware, special purpose processors, or a combination thereof. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software program, the actual connections between the system components (or the process steps) may differ depending upon the manner in which the present disclosure is programmed. Given the teachings herein, one of ordinary skill in the related art will be able to contemplate these and similar implementations or configurations of the present disclosure.

1. A method for volume control of content, comprising determining whether the content comprises both video data and audio data, and,
when the determination is positive, determining whether a country code defined in the parental rating information of the content is consistent with a language code of a current audio track of the content,
when a consistency is determined, adapting the volume of the content as a function of information on the rating of the content, and
when an inconsistency is determined, adapting the volume of the content as a function of the information on the type of the content.

2. The method according to claim 1, wherein the content represents a digital television program.

3. The method according to claim 2, wherein the parental rating information is obtained from the Parental Rating Descriptor from a DVB Event Information Table (EIT) table delivered for the digital television program.

4. The method according to claim 2, wherein the parental rating information is obtained from the Parental Rating Descriptor from an ATSC based Event Information Table (EIT) table delivered for the digital television program.

5. The method according to claim 2, wherein the information on the rating is obtained from the Parental Rating Descriptor from a DVB Event Information Table (EIT) table delivered for the digital television program.

6. The method according to claim 2, wherein the information on the type of the content is obtained from the Content Descriptor from a DVB Event Information Table (EIT) table delivered for the digital television program.

7. The method according to claim 1, further comprising implementing the method upon determination of the system time of the content being not in a set time period.

8. The method according to claim 7, further comprising presenting a user interface where in response to user input sets the time period.

9. A receiver for volume control of content, comprising:
a memory;
a processor configured to:
determine whether the content comprises both video data and audio data, and,
when the determination is positive, determine whether a country code defined in the parental rating information of the content is consistent with a language code of a current audio track of the content,
when a consistency is determined, adapt the volume of the content as a function of the information on the rating of the content, and
when an inconsistency is determined, adapt the volume of the content as a function of the information on the type of the content.

10. The receiver according to claim 9, wherein the receiver receives content representing a digital television program.

11. The receiver according to claim 10, wherein the parental rating information is obtained from the Parental Rating Descriptor from a DVB Event Information Table (EIT) table delivered for the digital television program.

12. The receiver according to claim 10, wherein the parental rating information is obtained from the Parental Rating Descriptor from an ATSC based Event Information Table (EIT) table delivered for the digital television program.

13. The receiver according to claim 10, wherein the information on the rating is obtained from the Parental Rating Descriptor from a DVB Event Information Table (EIT) table delivered for the digital television program.

14. The receiver according to claim 10, wherein the information on the type of the digital television program is obtained from the Content Descriptor from a DVB Event Information Table (EIT) table delivered for the digital television program.

15. The receiver according to claim 9, wherein the processor is further configured to implement the steps when the system time of the content is not in a set time period.

16. The receiver according to claim 15, wherein the receiver comprises a user interface unit to present a user interface where in response to user input sets the time period.

17. Computer program comprising program code instructions executable by a processor for implementing the steps of a method according to claim 1.

18. Computer program product which is stored on a non-transitory computer readable medium and comprises program code instructions executable by a processor for implementing the steps of a method according to claim 1.
